(19) United States
(12) Patent Application Publication
(10) Pub. No.: US 2004/0260567 A1
(43) Pub. Date: Dec. 23, 2004

(54) System and method of selling furniture

(76) Inventor: Rodney England, New Tazewell, TN (US)

Correspondence Address: HARNESS, DICKEY & PIERCE, P.L.C., P.O. BOX 828, BLOOMFIELD HILLS, MI, 48303, US

(21) Appl. No.: 10/465,801

(22) Filed: Jun. 19, 2003

(51) Int. Cl. G06F 17/60

(52) U.S. Cl. 705/1

(57) ABSTRACT

A system and method of selling furniture is disclosed. The system employs introduction mechanisms that surprise a customer and facilitate initiation of a dialogue. The system can be used with a gallery or a store within a store concept wherein a portion of the store is segregated and showcases furniture from a single manufacturing entity. The sales method employs various opportunities to engage a customer in a dialogue and present features and benefits of the furniture being showcased in a pleasant manner. The sales method does not subject a customer to a high pressure sales technique nor a completely passive sales technique.

### FIELD OF THE INVENTION

The present invention relates to furniture and more specifically to a system and method of selling furniture.

### BACKGROUND OF THE INVENTION

Furniture is typically sold in a retail store. The typical retail furniture store sells a variety of different types or pieces of furniture, such as sofas, loveseats, chairs, mattresses, dressers, etc. that are produced by a variety of manufacturers. In some stores, a specific manufacturer is highlighted by segregating a portion of the store to create a gallery or store within a store appearance. Within the segregated portion furniture from the specific manufacturer is showcased. That is, the major pieces of furniture within the segregated portion are all from the same manufacturer while ancillary pieces of furniture (e.g., lamps, clocks, rugs) within the segregated portion may be produced by different manufacturers. The use of a segregated portion of the store to showcase a specific manufacture is an attempt to draw the customer to the furniture in the segregated portion and to increase sales of the showcased furniture. The use of the gallery or store within a store concept, however, has not always lead to an increase in sales of the furniture made by the manufacturer that is showcased.

In an attempt to increase sales of furniture, some furniture stores have their employees or sale personnel utilize a high pressure or active sales technique on customers. That is, the sales personnel actively engage a customer who enters the store in a dialogue during all or a majority of the phases of the shopping experience. The high pressure sales technique attempts to ascertain the customer's wants and desires and to appeal to those wants and desires by suggesting or highlighting specific pieces of furniture within the store. Additionally, the sales personnel employing this technique typically attempt to close a sale with the customer on more than one occasion. That is, the sales personnel will regularly attempt to procure a commitment from the customer to buy a piece of furniture which has been shown to the customer. The high pressure or active sales approach, however, is not effective with all customers and is a turn-off to some customers. As a result, the high pressure sales technique does not always lead to an increase in sales and can alienate customers such that a customer who is comparison shopping will not return to the retail store out of dislike for the high pressure sales environment therein.

On the other end of the sales spectrum, some retail furniture stores provide a more passive sales environment wherein the sales personnel apply a passive or low pressure sales technique. The low pressure sales technique can include a general introduction by a sales personnel and an encouragement for the customer to browse the selection of furniture in the store. The sales personnel then allow the customer to browse the store without any further contact with the sales personnel unless such is initiated by the customer. The use of a passive or low pressure sales environment, however, also has drawbacks in that questions the customer may have regarding a piece of furniture in the retail store may go unasked and, accordingly, unanswered. Additionally, specific promotional features to which the customer may attach value may go unannounced and, thus, the customer will leave the store unaware of a specific promotional feature that would be beneficial to the customer and may have encouraged the customer to buy furniture at that time. Thus, the use of a passive or low pressure sales technique also may not increase sales and may result in lost sales opportunities.

Accordingly, it would be advantageous to employ a balanced sales technique that capitalizes on the positive attributes of both a low pressure or passive sales technique and of a high pressure or active sales technique. Additionally, it would be advantageous if such a balanced sales technique were employed while avoiding the negative aspects or drawbacks associated with each of the active and passive techniques discussed above. Furthermore, it is advantageous to a specific manufacturer of furniture that the balanced sales approach be used in conjunction with a store within a store concept wherein that manufacturer's furniture is showcased.

### SUMMARY OF THE INVENTION

The present invention discloses a sales method that utilizes feature benefit selling to highlight the benefits associated with a manufacturer's furniture while also providing a customer with an enjoyable experience and ample opportunity to independently browse the furniture that is offered for sale. Memory keys can be used with the sales method to remember the steps of the sales method. The present invention also discloses a system for facilitating the initiation of a dialogue with a customer that can be utilized with the sales method of the present invention to provide an enjoyable shopping experience and increase sales of the manufacturer's products.

A method of selling furniture according to the present invention includes initiating a dialogue with a customer upon the customer entering a predetermined portion of a retail store. The initiating of a dialogue includes: (1) presenting the customer with an introduction mechanism; and (2) surprising the customer through the requirement of the introduction mechanism to enter the predetermined portion of the retail store.

Another method of selling furniture in a retail store is also disclosed. The method includes: (1) using a first set of memory keys to convey to a customer feature benefits of furniture from a specific manufacturing entity; (2) ascertaining if the customer has purchased a piece of furniture from the manufacturing entity; and (3) using a second set of memory keys to convey additional feature benefits to the customer if the customer has not purchased a piece of furniture from the entity.

A system for selling furniture according to the principles of the present invention includes a retail store offering furniture for sale. There is furniture on display in the retail store. An introduction mechanism in the retail store is operable to initiate a dialogue in the retail store. The introduction mechanism includes a surprise mechanism.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified floor plan of a retail furniture store illustrating the system of selling furniture according to the principles of the present invention;

FIGS. 2A and B are a flow chart of a method of selling furniture according to the principles of the present invention;

FIG. 3 illustrates memory keys that can be utilized with the method of selling furniture according to the present invention;

FIGS. 4A and B are simplified representations of a name tag and a ticket that can be used when employing the sales method of the present invention;

FIG. 5 is a display rack containing samples of upholstery each having a label according to the principles of the present invention;

FIG. 6 is a simplified representation of a piece of furniture having a label that is keyed to the labels on the upholstery and with the seat cushions removed to show the available customized seat deck option according to the principles of the present invention;

FIG. 7 is a simplified fragmentary view of an arm portion of the piece of furniture of FIG. 6 within circle 7 and illustrating a hidden zipper in an open position to allow the adjustment of fiber filling in the arm portion;

FIGS. 8A-C are simplified views of a seat cushion having a self-healing zipper according to the principles of the present invention with the zipper being ruptured, open and closed respectively; and

FIG. 9 is a simplified perspective view of a brochure according to the principles of the present invention.

### DETAILED DESCRIPTION OF THE PREFERRED EMBODIMENT

The following description of the preferred embodiment is merely exemplary in nature and is in no way intended to limit the invention, its application, or uses.

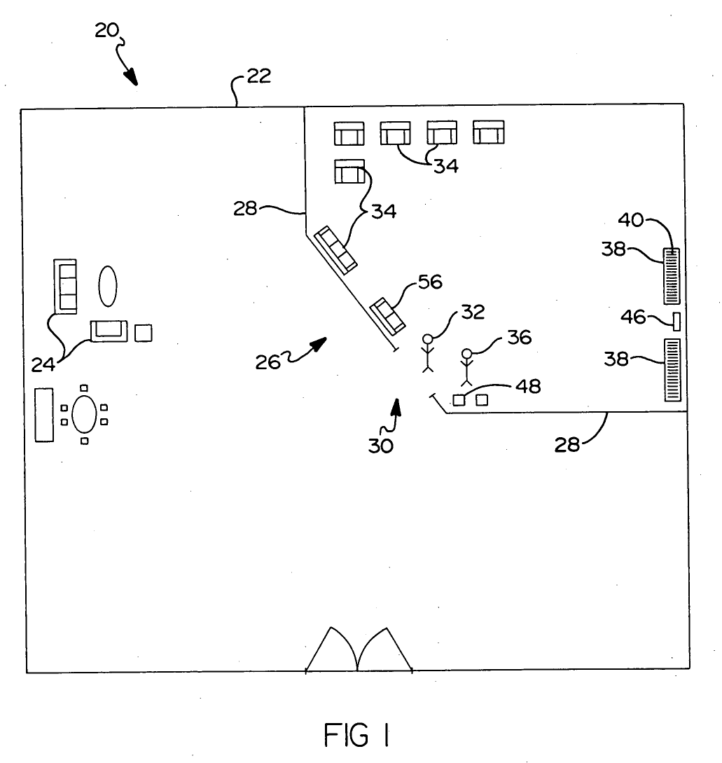

A system 20 for selling furniture according to the principles of the present invention is shown in FIG. 1. System 20 utilizes a gallery or store within a store concept for selling furniture. There is a retail store 22 which sells a variety of furniture, generally indicated as 24, that is produced by multiple manufacturing entities. A predetermined portion, generally indicated as 26, of retail store 22 is segregated off from the rest of retail store 22 with a wall or barrier 28. Wall 28 is not required to extend up to a ceiling of retail store 22. Rather, wall 28 may extend upward from the floor a portion of the distance to the ceiling so that portion 26 of retail store 22 is an open environment with the rest of retail store 22. Portion 26 has a single entryway 30 through which a customer 32 enters and exits portion 26 of retail store 22. It should be appreciated, that other exits from portion 26 may be provided as required by state and local regulations, such as a fire door or exit without departing from the scope of the present invention.

Portion 26 of retail store 22 is used to showcase furniture 34 that is produced by a single manufacturing entity or related manufacturing entities. That is, all the major pieces of furniture 34 within portion 26 of retail store 22 are from the same manufacturing entity or related manufacturing entities. It should be appreciated, however, that ancillary furniture items, such as lamps, rugs, clocks, art work, etc. that the single manufacturing entity does not produce may be included in portion 26 of retail store 22 to provide a desired appearance for portion 26. A sign (not shown) indicating the showcased manufacturing entity is positioned above or adjacent entryway 30 to draw attention to customer 32 that portion 26 is a showcase emphasizing furniture produced by the manufacturing entity listed in the sign.

A salesperson 36 is stationed proximate entryway 30 so that salesperson 36 can greet customer 32 upon entering portion 26 of retail store 22, as described below. Display racks 38 are located in portion 26 of retail store 22. Each display rack 38, as shown in FIG. 5, includes a plurality of samples 40 of upholstery that can be selected for use with furniture 34 within portion 26 of retail store 22. Each sample 40 has a label or tag 42 that contains indicia 44 that is indicative of which pieces of furniture 34 can be purchased with the upholstery shown on that sample 40, as described below. A display sign 46 is located in portion 26 of retail store 22 adjacent a display rack 38. Display sign 46 has a display that indicates a delivery date for a piece of furniture 34 within portion 26 of retail store 22 that is ordered today. Preferably, display sign 46 is a flashing sign or has other visually stimulating effects to draw the attention of customer 32.

A storage device 48, such as a table or display rack, is located proximate entryway 30 so that it is easily accessible by salesperson 36. Storage device 48 contains a plurality of name tags 50, such as that shown in FIG. 4A, and a plurality of tickets 52, such as that shown in FIG. 4B. Name tag 50 and ticket 52 are used by salesperson 36 as introduction mechanisms to start a dialogue with customer 32. These introduction mechanisms surprise customer 32, as described below. Storage device 48 also contains a plurality of brochures 54, such as that shown in FIG. 9, that salesperson 36 gives to customer 32 upon leaving portion 26 of retail store 22 without having purchased a piece of furniture 34, as described below.

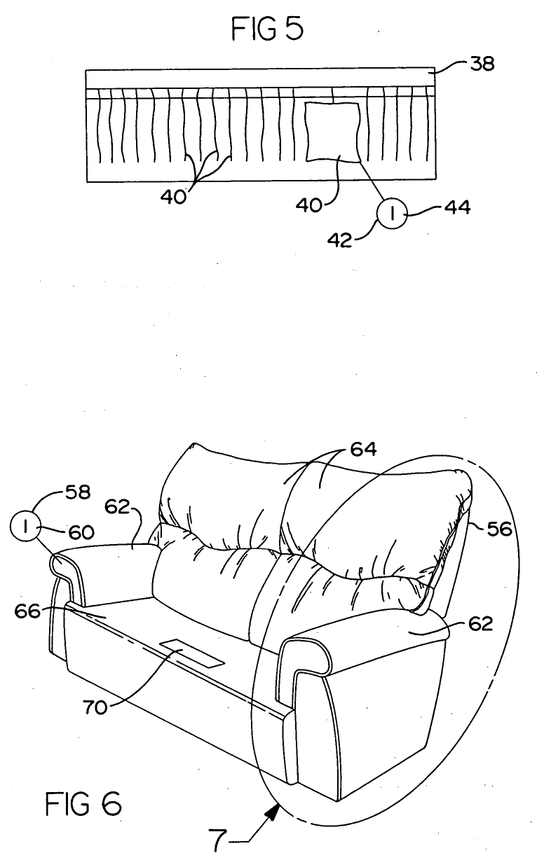

A demonstration piece of furniture 56, in this case in the form of a sofa which can best be seen in FIG. 6, is positioned proximate entryway 30 so that it is easily accessible by salesperson 36. Demonstration sofa 56 includes a tag or label 58 with indicia 60 that is keyed to indicia 44 on tag 42 to enable customer 32 to ascertain if the piece of furniture having tag 58 is available with a particular type of upholstery shown in one of the samples 40. For example, tag 58 is shown having indicia 60 that is the number “1” while sample 40 has a tag 42 with indicia 44 that is also a number “1,”. The matching of indicia 44 and 60 on sample 40 and sofa 56 indicates that that particular sofa 56 is available with the upholstery shown on that particular sample 40.

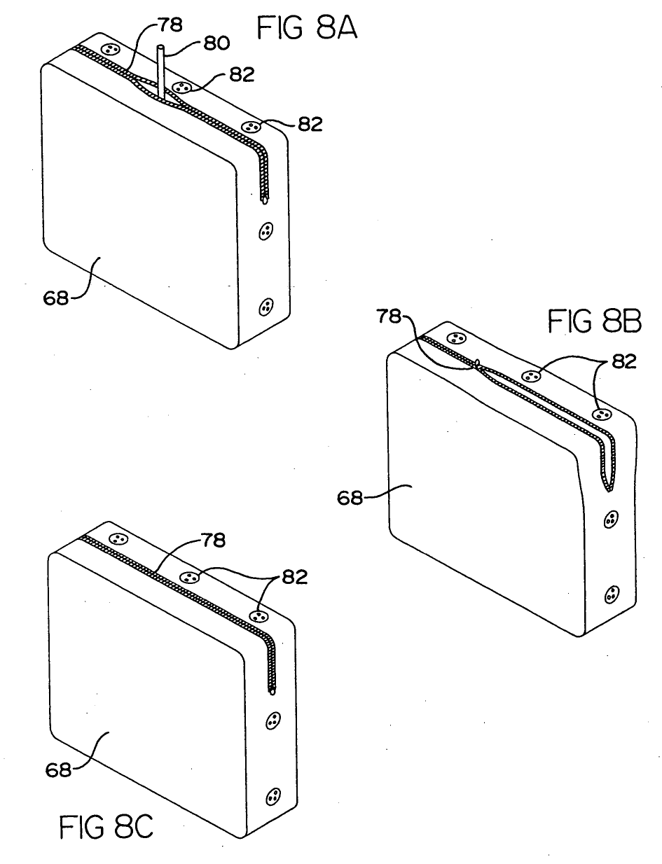

Demonstration sofa 56 is indicative of other furniture 34 within portion 26 of retail store 22. Demonstration sofa 56 is used to demonstrate the various features of furniture 34 within portion 26 of retail store 22 along with the possible upgrades. Demonstration sofa 56 has a pair of arm portions 62, back cushions 64 and a seat deck 66 upon which seat cushions 68 (not shown in FIG. 6 so that seat deck 66 is visible) reside, such as those shown in FIGS. 8A-C. Each piece of furniture 34 in portion 26 of retail store 22 has an upgraded seat deck option. Specifically, an upgraded seat deck, such as seat deck 66 on demonstration sofa 56 includes an upgrade to a better fabric from which seat deck 66 is made along with the ability for the customer to have indicia 70 on seat deck 66 customized to be individually monogrammed as specified by customer 32. That is, indicia 70 can be specified by customer 32 to contain the customer's name, initials or other information as specified by customer 32. Thus, demonstration sofa 56 has an upgraded seat deck 66 that enables salesperson 36 to show customer 32 this available option and the availability of customizing indicia 70 on seat deck 66.

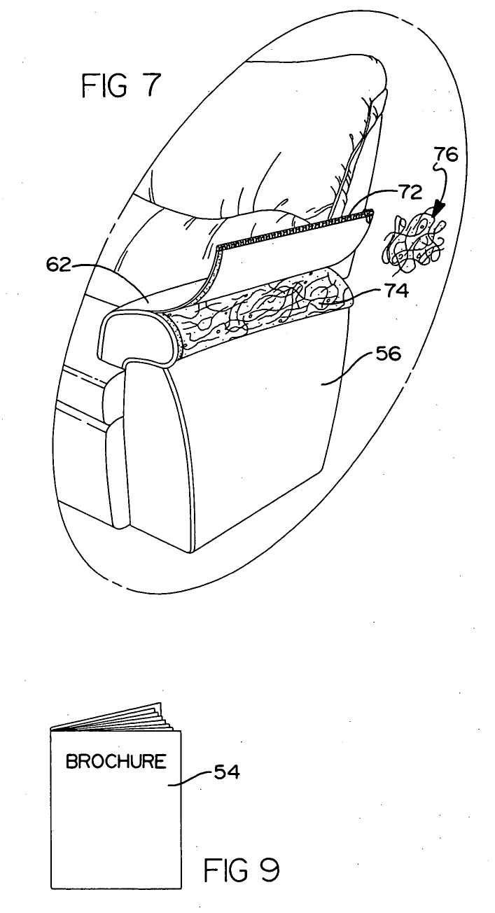

Demonstration sofa 56, like the other pieces of furniture 34 in portion 26 of retail store 22, can be customized by customer 32 to provide a desired comfort or level of padding. That is, the polyester fiber that is used to provide comfort and padding on various portions of furniture 34 can be adjusted by customer 32 to a desired level or quantity. To allow the adjustment of the amount of polyester fiber filling, all of the furniture 34 has a number of hidden zippers that allow access to the portions of the furniture 34 that contain polyester fiber filling so that the quantity of polyester fiber filling can be adjusted by customer 32. For example, as shown in FIG. 7, arm portion 62 of demonstration sofa 56 has a zipper 72 which is normally hidden from view by being positioned on the underside of arm portion 62. Zipper 72 allows customer 32 and/or salesperson 36 to unzip arm portion 62, as shown, to expose fiber filling 74 in arm portion 62. There is a supply of extra polyester fiber filling 76 located in portion 26 of retail store 22 proximate demonstration sofa 56. Extra fiber filling 76 can be used to add additional fiber filling to arm portion 62 by unzipping zipper 72, as shown in FIG. 7, and inserting extra fiber filling 76 on top of fiber filling 74. Once customer 32 and/or salesperson 36 has adjusted the quantity of fiber filling 74 in arm portion 62 to a desired level, zipper 74 can be zipped closed and zipper 72 is hidden from view on the underside of arm portion 62. Thus, the quantity of fiber filling 74 in arm portion 62 of demonstration sofa 56 can be adjusted by customer 32 and/or salesperson 36.

In addition to being able to adjust the fiber filling in arm portion 62, each location where fiber filling is used on each piece of furniture 34 in portion 26 of retail store 22 is adjustable. That is, fiber filling is utilized not only in arm portion 62 of demonstration sofa 56 but also in back cushion 64 and/or seat cushion 68. To allow adjustment of the polyester fiber filling in these parts of demonstration sofa 56, additional hidden zippers (not shown) are provided to access back cushion 64 and seat cushion 68. Thus, the quantity of polyester fiber filling in furniture 34 within portion 26 of retail store 22 is adjustable by customer 32 to provide a desired level of comfort. The adjustability of the quantity of fiber filling enables different portions of a piece of furniture to have varying levels of cushioning. For example, one seat cushion 68 can be adjusted to be firmer for a heavier person while a different seat cushion 68 can be adjusted to be softer for a lighter person and results in a comfortable seat for both the heavier and lighter person on the same piece of furniture. Salesperson 36 and/or customer 32 can also use the access to the fiber filled portion(s) to “fluff” the fibers in addition to or instead of adjusting the quantity of the fiber filling.

Another feature of furniture 34 within portion 26 of retail store 22 is the use of self-healing zippers at all locations where a zipper is used. For example, referring to FIGS. 8A-C, seat cushion 68 has a zipper 78 which is self-healing. That is, as shown in FIG. 8A, zipper 78 can be ruptured by a pointed object 80, such as a pen. The self-healing properties of zipper 78 allow such ruptures to be easily remedied by unzipping zipper 78 past the location of the rupture, as shown in FIG. 8B, and then moving zipper 78 to a closed position past the location of the rupture, as shown in FIG. 8C. Thus, the self-healing zipper 78 is a feature that can be demonstrated to customer 32 by salesperson 36, as described below.

Another feature of furniture 34 within portion 26 of retail store 22 is that vents 82 are provided on seat cushion 68 to enhance the performance of the foam cushion (not shown) within each seat cushion 68. That is, vents 82 allow for the efficient removal and addition of air in the foam cushion within seat cushion 68. The efficient removal and addition of air increases the performance of seat cushion 68. Additionally, vents (not shown) are also provided on furniture 34 within portion 26 of retail store 22 at locations where other foam cushions are compressed and expanded as the piece of furniture is being used.

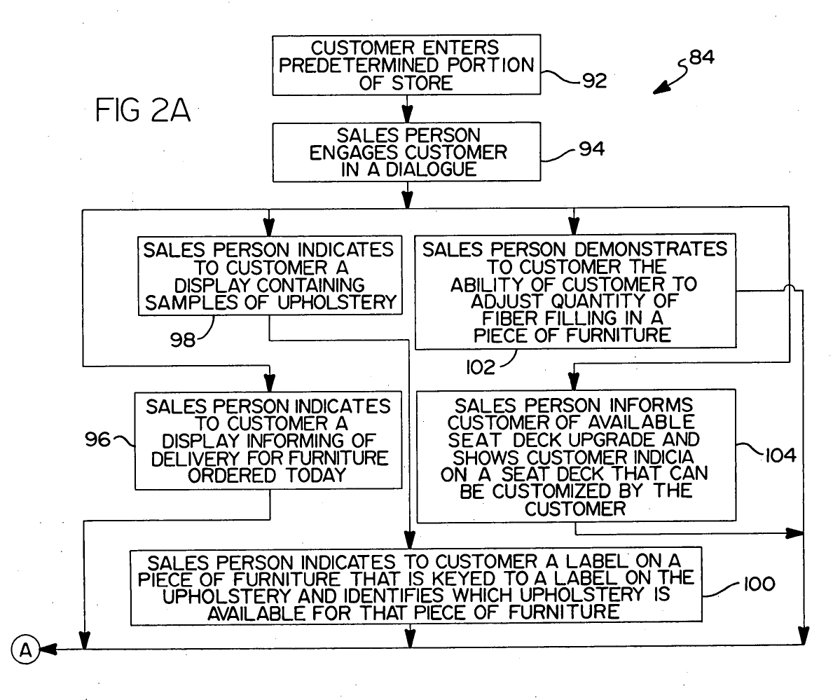

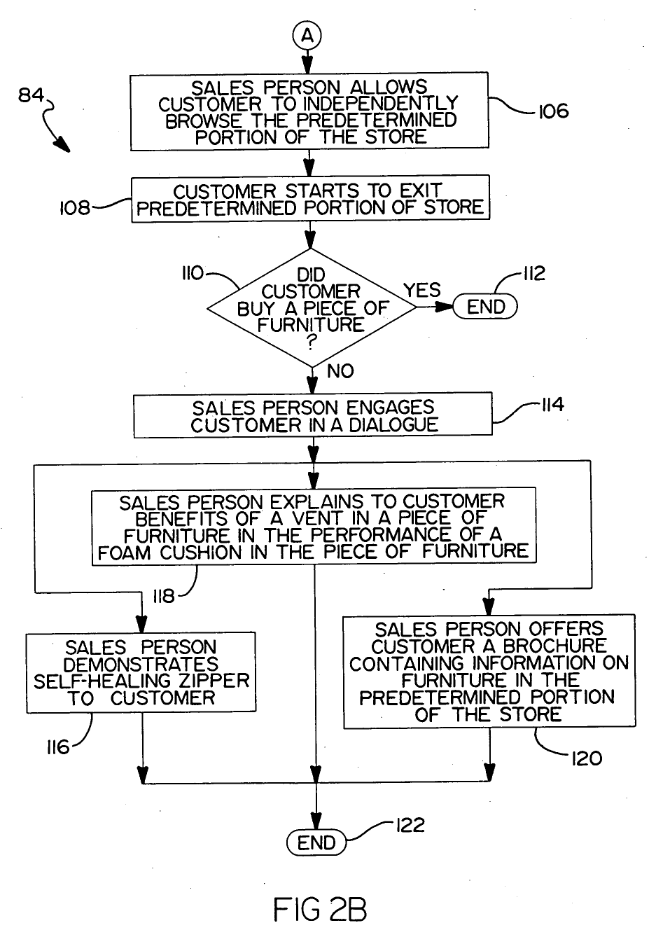

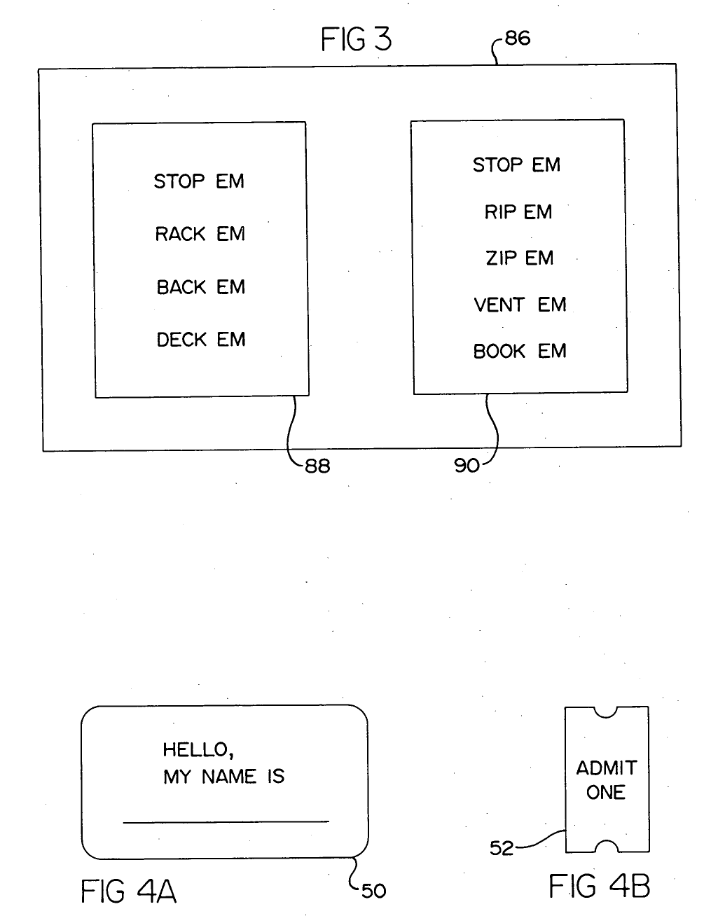

A method 84 of selling furniture 34 within portion 26 of retail store 22 is shown in FIGS. 2A-B. Sales method 84 utilizes feature benefit selling and provides a low pressure sales pitch to customer 32 while also advocating the beneficial features of furniture 34 in portion 26 of retail store 22 over that of other furniture within retail store 22 or other furniture stores. Sales method 84 provides an enjoyable and pleasing experience for customer 32 when shopping for furniture within portion 26 of retail store 22. Memory keys 86, as shown in FIG. 3, can be used by salesperson 36 to remember the various steps of sales method 84 and to maintain the correct sequencing of the various steps of sales method 84. Memory keys 86 include a first or initial set of memory keys 88 that are used in the first portion of sales method 84 and a second or final set of memory keys 90 that are used in the second portion of sales method 84, as described below.

Sales method 84 begins when customer 32 enters portion 26 of retail store 22 through entryway 30, as indicated in block 92. Once customer 32 has entered portion 26 of retail store 22, salesperson 36, who is located proximate entryway 30, engages customer 32 in a dialogue, as indicated in block 94. This is the “stop em” portion of first set of memory keys 88. In this part of sales method 84, salesperson 36 engages customer 32 in a dialogue that is unconventional through the use of one or more of the introduction mechanisms described above. That is, the introduction mechanisms facilitate salesperson 36 saying something unexpected that will shock or surprise customer 32 and gains the attention of customer 32. For example, salesperson 36 may stop customer 32 and say “You need a name tag to enter this portion of the store.” This statement surprises customer 32 and salesperson 36 hands customer 32 a name tag 50 that is located on storage device 48. Alternately, salesperson 36 can inform customer 32 that a ticket is needed to enter portion 26 of retail store 22 which also surprises customer 32. Contemporaneously with or subsequent to informing customer 32 of the need for a ticket, salesperson 36 gives customer 32 one of the tickets 52 in storage device 48. The requirement for a name tag 50 and/or a ticket 52 to enter portion 26 of retail store 22 surprises or catches customer 32 off guard and provides the initiation of a dialogue between salesperson 36 and customer 32. Thus, the introduction mechanism acts as a surprise mechanism that facilitates the initiation of a dialogue between salesperson 36 and customer 32. With the dialogue initiated, salesperson 36 informs customer 32 that portion 26 of retail store 22 is not a traditional furniture store in that portion 26 is a showcase of furniture 34 offered by a single manufacturing entity. Salesperson 36 then begins the feature benefit selling process that includes four different benefits that salesperson 36 wants to convey to customer 32 and uses the mnemonics of first set of memory keys 88 to remember the four benefits to convey.

Salesperson 36 with the assistance of memory keys 86 conveys a first benefit by indicating to customer 32 display sign 46 within portion 26 of retail store 22, as indicated in block 96. This is part of the “rack em” portion of first set of memory keys 88 as display sign 46 is adjacent display racks 38 which are a rack of samples 40. Salesperson 36 shows customer 32 display sign 46 and explains that the date shown on display sign 46 indicates the delivery date for a piece of furniture 34 within portion 26 of retail store 22 that is ordered today. That is, salesperson 36 tells customer 32 that any piece of furniture 34 which is ordered today will be delivered by the date shown on the display sign 46 and that salesperson 36 does not need to look up or call the manufacturer to determine when the piece of furniture will be available for delivery.

Salesperson 36 with the assistance of memory keys 86 conveys a second benefit by indicating to customer 32 display racks 38 containing samples 40 of upholstery that can be specified for furniture 34, as indicated in block 98. This is the remaining part of the “rack em” portion of first set of memory keys 88. Salesperson 36 explains that the various samples 40 can be ordered for a variety of the pieces of furniture 34 within portion 26 of retail store 22 and that a tag 42 located on each sample 40 is used to determine which upholstery is available with which piece of furniture. Salesperson 36 also indicates to customer 32 tag 58 on demonstration sofa 56 which is keyed to tags 42 on samples 40, as indicated in block 100. Salesperson 36 explains that tag 58 contains indicia 60 which is keyed to indicia 44 on tags 42. When indicia 44 on tag 42 and indicia 60 on tag 58 are the same, in this case both the number “1”, that indicates that the upholstery shown in that sample 40 is available for the piece of furniture having tag 58 with matching indicia 60. Thus, customer 32 is made aware of how the various upholstery samples 40 can be matched to the various pieces of furniture 34 through tags 42 and 58 to determine which pieces of furniture 34 are available with which samples of upholstery 40. While tags 42 and 58 are shown having indicia 44 and 60 that contains a number, it should be appreciated that tags 42 and 58 can be keyed together by other means, such a color coding tags 42 and 58 to have the same color when the sample 40 is available for the piece of furniture on which tag 58 is affixed, without departing from the scope of the present invention.

Salesperson 36 with the assistance of memory keys 86 conveys a third benefit by demonstrating to customer 32 the ability of customer 32 to adjust a quantity of fiber filling in a piece of furniture 34, as indicated in block 102. This is the “back em” portion of first set of memory keys 88 as the quantity of fiber filling in a back cushion 64 of furniture 34 can be adjusted as described above. To demonstrate this benefit, salesperson 36 informs customer 32 that furniture 34 contains numerous hidden zippers that allow access to the fiber filling that is, used in various locations in the furniture 34. Salesperson 36 then demonstrates this ability on a back cushion 64, seat cushion 68 and/or arm portion 62 of demonstration sofa 56. For example, salesperson 36 unzips zipper 72 on arm portion 62 of demonstration sofa 56. With zipper 72 unzipped, salesperson 36 can pull back the upholstery covering arm portion 62 to expose fiber filling 74 in arm portion 62. Salesperson 36 can then adjust the amount of fiber filling 74 in arm portion 62 by adding some of the extra fiber filling 76 or extracting some of the fiber filling 74. After adjusting the fiber filling 74, salesperson 36 can then close zipper 72 to return arm portion 62 to its normal state. If desired, customer 32 can also adjust the amount of fiber filling 74 in arm portion 62 to gain first hand experience on the ability to adjust the quantity of fiber filling 74 in arm portion 62. Salesperson 36 also indicates to customer 32 the location of other hidden zippers on other portions of demonstration sofa 56 containing fiber filling that can be adjusted by customer 32. Salesperson 36 explains that all of the locations on furniture 34 having fiber filling can be adjusted by customer 32 through one or more hidden zippers. Alternately, as stated above, salesperson 36 can demonstrate the adjusting of fiber filling in a portion of demonstration sofa 56 other than arm portion 62, such as the adjustment of a fiber filling in back cushion 64 and/or seat cushion 68. Salesperson 36 can also inform customer 32 that, if desired, the access to the fiber filled portions can be utilized to “fluff” the fiber filling instead of or in addition to adjusting the quantity of the fiber filling. Thus, salesperson 36 has demonstrated to customer 32 the ability of customer 32 to customize the amount of fiber filling within various portions of furniture 34 produced by the manufacturing entity.

Salesperson 36 with the assistance of memory keys 86 conveys a fourth benefit by informing customer 32 of the available upgraded seat deck 66, as indicated in block 104. This is the “deck em” portion of first set of memory keys 88 as it pertains to seat deck 66. Salesperson 36 shows customer 32 seat deck 66 on demonstration sofa 56. Salesperson 36 explains that the fabric that forms seat deck 66 is an upgraded fabric and can be customized with indicia 70 as specified by customer 32. For example, salesperson 36 informs customer 32 that indicia 70 can be chosen to read “Custom Made For ______” with the customer's name and/or initials substituted for the underlined portion. It is important to inform customer 32 of the available upgraded seat deck 66 prior to customer 32 browsing portion 26 of retail store 22. This is important because the upgraded seat deck option costs additional money and customer 32 will believe salesperson 36 has more integrity by not trying to sell upgrades that cost additional money to customer 32 after having made a buying decision.

Salesperson 36 can indicate and/or demonstrate the four benefits described above and indicated in blocks 96, 98,102 and 104 in any order without departing from the scope of the present invention. That is, salesperson 36 may choose to inform the customer 32 of the available seat deck upgrade prior to demonstrating the ability to adjust the quantity of fiber filling. Additionally, salesperson 36 may desire to inform customer 32 about the matching of upholstery samples 40 with various pieces of furniture 34 prior to indicating the display sign 46 that indicates the delivery date for a piece of furniture 34 ordered today. The use of first set of memory keys 88 helps salesperson 36 remember the benefits to be conveyed to customer 32 even when the benefits are not conveyed in the order of the mnemonic shown in first set of memory keys 88. That is, first set of memory keys 88 can be used as a mental checklist that salesperson 36 goes through to ensure that all of the benefits have been conveyed to customer 32 before advancing to the next step of sales method 84. Thus, the four benefits mentioned above can be indicated/demonstrated to customer 32 in different sequences without departing from the scope of the present invention. Salesperson 36 can also inform customer 32 of additional features or benefits of buying furniture from salesperson 36. For example, salesperson 36 may choose to discuss a service policy of retail store 22 along with any special financing or purchase incentives that may be offered by retail store 22.

During the next phase of sales method 84, salesperson 36 allows customer 32 to independently browse portion 26 of retail store 22, as indicated in block 106. Customer 32 is then able to look at the various pieces of furniture 34 with full knowledge of the benefits of the furniture 34 within portion 26 of retail store 22 that were explained by salesperson 36. During this stage, salesperson 36 can answer any questions customer 32 poses to salesperson 36. Salesperson 36, however, does not actively continue to engage customer 32 in a dialogue unless initiated and/or continued by customer 32. Customer 32, if they find a piece of furniture 34 that they wish to purchase can then purchase such piece of furniture 34 from salesperson 36 within portion 26 of retail store 22. Customer 32, however, may choose not to purchase any piece of furniture 34 within portion 26 of retail store 22 and will start to exit portion 26 through entryway 30, as indicated in block 108.

When customer 32 begins to exit portion 26 of retail store 22, salesperson 36 ascertains whether customer 32 purchased a piece of furniture or not, as indicated in decision block 110. If customer 32 purchased a piece of furniture 34, sales method 84 is complete, as indicated in block 112. If customer 32 did not purchase a piece of furniture 34, salesperson 36 with the assistance of memory keys 86 engages customer 32 in another dialogue, as indicated in block 114. This is the “stop em” portion of second set of memory keys 90. Engaging customer 32 in this dialogue is facilitated by the dialogue that salesperson 36 initiated with customer 32 in block 92 of sales method 84. That is, salesperson 36 can request customer 32 to return name tag 50 and/or ticket 52 that was given to customer 32 to allow customer 32 to enter portion 26 of retail store 22. Salesperson 36 uses this dialogue with customer 32 to express that salesperson 36 realizes customer 32 has not purchased a piece of furniture 34 and that salesperson 36 would like to educate customer 32 on additional features to look for in other furniture customer 32 may look at. In other words, salesperson 36 uses this second dialogue with customer 32 to further highlight benefits of furniture 34 within portion 26 of retail store 22 so that when customer 32 comparison shops some of the benefits of the furniture 34 in portion 26 of retail store 22 will be remembered by customer 32.

Salesperson 36 with the assistance of memory keys 86 conveys a first additional benefit to customer 32 by demonstrating one or more of the self-healing zippers in furniture 34 within portion 26 of retail store 22, as indicated in block 116. For example, salesperson 36 grabs seat cushion 68, which is positioned proximate entryway 30, and proceeds to rupture zipper 78 with a pointed object 80, such as a pen, as shown in FIG. 8A. This is the “rip em” portion of second set of memory keys 90 due to the “ripping” open or rupturing of zipper 78. While doing this, salesperson 36 informs customer 32 that all of the zippers on furniture 34 within portion 26 of retail store 22 are self-healing zippers and that customer 32 should look for this feature when comparison shopping. Salesperson 36 then proceeds to remove pen 80 from the rupture and opens zipper 78 past the location of the rupture, as shown in FIG. 8B. Salesperson 36 then proceeds to close zipper 78 past the previously ruptured location, as shown in FIG. 8C, to demonstrate to customer 32 that zipper 78 is self-healing and repairs itself when ruptured. This is the “zip em” portion of second set of memory keys 86 due the zipping aspect of this demonstration. Thus, customer 32 is now informed that the furniture 34 showcased in portion 26 of retail store 22 utilizes self-healing zippers so that a rupturing of the zipper is not a problem and that customer 32 should look for this feature when comparison shopping.

Salesperson 36 with the assistance of memory keys 86 conveys a second additional feature to customer 32 by explaining the benefit of a vent 82 in furniture 34 to increase the performance of a foam cushion, as indicated in block 118. This is the “vent em” portion of second set of memory keys 90. Specifically, salesperson 36 points to vents 82 on seat cushion 68 and informs customer 32 that the performance of the foam cushion (not shown) in seat cushion 68 is dependent upon the ability of the seat cushion to pull air back into the cushion upon being unloaded. With this benefit in mind and the effect it has on the performance of seat cushion 68, salesperson 36 instructs customer 32 to make sure any product or piece of furniture they end up buying has one or more of these vents to allow the air back into the cushion so that the performance of the cushion is enhanced.

Salesperson 36 with the assistance of memory keys 86 also offers customer 32 a brochure 54 that contains information on furniture 34 within portion 26 of retail store 22, as indicated in block 120. This is the “book em” portion of second set of memory keys 90. Specifically, brochures 54 are located in storage device 48 which is proximate entryway 30 so that brochures 54 are easily accessible by salesperson 36. This facilitates salesperson 36 giving customer 32 a brochure 54 when customer 32 is exiting portion 26 through entryway 30. Salesperson 36 in addition to offering customer 32 a brochure 54 also takes time to explain the contents of brochure 54. For example, salesperson 36 can open brochure 54 to a center section wherein there is a work sheet having grids and various furniture cut outs that can be cut out and placed on the grid to represent the furnishing of a room. In addition to the grid and the cut outs, brochure 54 also contains useful information about the various products and features that were explained to customer 32 during sales method 84.

The actions indicated in blocks 116, 118 and 120 can be presented to customer 32 in any order. It is preferred, however, that the offering to customer 32 of brochure 54, as indicated in step 120, be performed after demonstrating the self-healing zipper and explaining the benefits of a vent. The use of second set of memory keys 90 by salesperson 36 ensures that salesperson 36 does not forget a step in sales method 84.

Customer 32 has now received information and/or demonstrations from salesperson 36 that highlight the various benefits and features of furniture 34 within portion 26 of retail store 22. This information has been provided to customer 32 in a non-aggressive manner with no pressure being placed on customer 32 to purchase a piece of furniture 34 today. Additionally, customer 32 can now comparison shop furniture 34 showcased within portion 26 of retail store 22 against furniture produced by other manufacturing entities in retail store 22 or other retail stores with the knowledge of the features and benefits of the furniture 34 being showcased. Sales method 84 is now ended, as indicated in block 122 and customers 32 who say they are just looking and will be back will actually return to purchase a piece of furniture 34 from portion 26 of retail store 22 at a higher frequency than if sales method 84 were not employed.

Thus, system 20 in conjunction with sales method 84 and memory keys 86 can provide an enhanced shopping experience for a customer 32 wherein customer 32 is educated about the benefits of furniture 34 showcased within portion 26 of retail store 22 in a pleasing manner. This education on the various benefits is performed in a non-aggressive manner and without the use of a hard sales pitch. Additionally, sales method 84 facilitates interaction between salesperson 36 and customer 32 to provide the information regarding the benefits of furniture 34 being showcased within portion 26 of retail store 22 while avoiding the lack of education about benefits and features associated with a low pressure or passive sales technique. Additionally, the use of memory keys 86 by salesperson 36 helps to ensure that all of the steps of sales method 84 are performed by salesperson 36 through the provision of easily remembered mnemonics in memory keys 86.

It should be appreciated, that sales method 84 provides customer 32 with specific features and benefits that may be limited to furniture 34 produced by a specific manufacturing entity. Accordingly, sales method 84 can be used in a retail store 22 that is dedicated to furniture 34 being offered by a specific manufacturing entity. For example, sales method 84 can be employed in a factory store or a showcase store wherein all the major pieces of furniture are provided by a single manufacturing entity. In this situation, retail store 22 does not need to be partitioned into a portion 26 because all the major pieces of furniture within retail store 22 are produced by the single manufacturing entity. In this situation, entryway 30 is essentially the main entrance to retail store 22. Thus, it should be appreciated that sales method 84 can be employed in a retail store 22 that has a segregated portion 26 to showcase furniture from a single manufacturing entity or in a retail store 22 that is used in its entirety to showcase furniture from a single manufacturing entity, without departing from the scope of the present invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of selling furniture, the method comprising:
initiating a dialogue with a customer upon said customer entering a predetermined portion of a retail store, initiating a dialogue including:
presenting said customer with an introduction mechanism; and
surprising said customer through the requirement of said introduction mechanism to enter said predetermined portion of said retail store.

2. The method of claim 1, wherein said introduction mechanism is a name tag and further including requesting that said customer wear said name tag in said portion of said retail store.

3. The method of claim 1, wherein said introduction mechanism is a ticket and further including requesting said customer to take said ticket.

4. The method of claim 1, further comprising asking said customer to return said introduction mechanism when said customer attempts to leave said portion of said retail store.

5. The method of claim 1, wherein said portion of said retail store is an entire portion of said retail store.

6. A method of selling furniture, the method comprising:
engaging a customer in a dialogue upon entering a predetermined portion of a retail store;
indicating to said customer a display in said portion of said retail store that informs said customer of a delivery date for furniture on display in said portion of said retail store that is ordered today; and
allowing said customer to independently browse said portion of said retail store.

7. The method of claim 6, further comprising:
engaging said customer in a dialogue when said customer is attempting to exit said portion of said retail store without having purchased a piece of furniture; and
demonstrating to said customer a self-healing zipper feature on a piece of furniture in said portion of said retail store.

8. The method of claim 7, further comprising:
explaining to said customer benefits of having a vent in a piece of furniture on a performance of a foam cushion in said piece of furniture; and
showing said customer a location of at least one vent on a piece of furniture in said portion of said retail store.

9. The method of claim 8, further comprising offering to said customer a brochure containing information on said furniture in said portion of said retail store.

10. The method of claim 7, wherein demonstrating to said customer a self-healing zipper feature includes:
rupturing a closed portion of said zipper;
opening said zipper past a ruptured portion of said zipper; and
closing said zipper at least past a location where said zipper was ruptured.

11. The method of claim 6, further comprising:
demonstrating on at least one piece of furniture on display in said portion of said retail store an ability of said customer to adjust a quantity of fiber filling in said one piece of furniture; and
informing said customer that fiber filling in all pieces of furniture in said portion of said retail store is adjustable.

12. The method of claim 11, wherein demonstrating further includes:
showing said customer a location of at least one hidden zipper on said one piece of furniture;
unzipping said hidden zipper; and
adjusting a quantity of said fiber filling in said one piece of furniture.

13. The method of claim 12, wherein said at least one hidden zipper is on an arm portion of said one piece of furniture.

14. The method of claim 6, further comprising:
indicating to said customer a display containing samples of upholstery that can be selected for a multitude of pieces of furniture on display in said portion of said retail store; and
indicating to said customer a label on said pieces of furniture that is keyed to a label on said samples of upholstery to identify which upholstery is available for that piece of furniture.

15. The method of claim 6, further comprising informing said customer of an available seat deck upgrade for said furniture that includes a customer specified indicia on said seat deck prior to allowing said customer to independently browse.

16. The method of claim 6, wherein engaging said customer in a dialogue includes informing said customer that a name tag is required to enter said portion of said retail store and giving said customer a name tag.

17. The method of claim 6, wherein engaging said customer in a dialogue includes informing said customer that a ticket is required to enter said portion of said retail store and giving said customer a ticket.

18. The method of claim 6, wherein said portion of said retail store is an entire portion of said retail store.

19. A method of selling furniture in a segregated portion of a retail store, the method comprising:
engaging a customer in a first dialogue upon entering the portion of the retail store;
indicating to said customer a first display in the portion of the retail store that informs said customer of a delivery date for furniture on display in the portion of the retail store that is ordered today;
indicating to said customer a second display containing samples of upholstery that can be selected for a multitude of pieces of furniture on display in the portion of the retail store;
indicating to said customer a label on said pieces of furniture that is keyed to a label on said samples of upholstery to identify which upholstery is available for that piece of furniture;
demonstrating on at least one of said pieces of furniture an ability of said customer to adjust a quantity of fiber filling in said one piece of furniture;
informing said customer of an available seat deck upgrade for said furniture that includes a customer specified indicia on said seat deck;
allowing said customer to independently browse the portion of the retail store;
engaging said customer in a second dialogue when said customer is attempting to exit the portion of the retail store without having purchased a piece of furniture;
demonstrating to said customer a self-healing zipper feature on a piece of furniture in the portion of the retail store;
explaining to said customer benefits of having a vent in a piece of furniture on a performance of a foam cushion in said piece of furniture; and
offering to said customer a brochure containing information on said furniture in the portion of the retail store.

20. The method of claim 19, wherein engaging in said first dialogue includes informing said customer that a name tag is required to enter the portion of the retail store and giving said customer a name tag and engaging in said second dialogue includes asking said customer to return said name tag.

21. The method of claim 19, wherein engaging in said first dialogue includes informing said customer that a ticket is required to enter the portion of the retail store and giving said customer a ticket and engaging in said second dialogue includes asking said customer to return said ticket.

22. The method of claim 19, wherein demonstrating an ability to adjust a quantity of fiber filling includes:
showing said customer a location of at least one hidden zipper on said one piece of furniture;
unzipping said hidden zipper; and
adjusting a quantity of said fiber filling in said one piece of furniture.

23. The method of claim 19, wherein demonstrating to said customer said self-healing zipper includes:
rupturing a closed portion of said zipper;
opening said zipper past a ruptured portion of said zipper; and
closing said zipper at least past a location where said zipper was ruptured.

24. The method of claim 19, further comprising showing said customer a location of at least one vent on a piece of furniture in the portion of the retail store.

25. A method of selling furniture in a retail store, the method comprising:
(a) using a first set of memory keys to convey to a customer feature benefits of furniture from a specific manufacturing entity;
(b) ascertaining if said customer has purchased a piece of furniture from said manufacturing entity; and
(c) using a second set of memory keys to convey additional feature benefits to said customer if said customer has not purchased a piece of furniture from said entity.

26. The method of claim 25, wherein step (a) includes using said first set of memory keys when said customer enters a predetermined portion of the store and step (c) includes using said second set of memory keys when said customer is exiting said predetermined portion of the store.

27. The method of claim 26, wherein step (a) includes:
using a first key of said first set of memory keys to indicate to said customer a display in the predetermined portion of the retail store that informs said customer of a delivery date for furniture from said entity that is ordered today;
using said first key of said first set of memory keys to indicate to said customer another display containing samples of upholstery that can be selected for a multitude of pieces of furniture from said and indicating to said customer a label on said furniture from said entity that is keyed to a label on said samples of upholstery to identify which upholstery is available for that piece of furniture;
using a second key of said first set of memory keys to inform said customer of an available seat deck upgrade; and
using a third key of said first set of memory keys to inform said customer of an ability of said customer to adjust a quantity of fiber filling in said furniture from said entity.

28. The method of claim 26, wherein step (c) includes:
using a first key of said second set of memory keys to inform said customer of the use of self-healing zippers on furniture from said entity;
using a second key of said second set of memory keys to inform said customer of the benefits of a vent in a piece of furniture on a performance of a foam cushion in said piece of furniture; and
using a third key of said second set of memory keys to offer said customer a brochure containing information on furniture from said entity.

29. A system for selling furniture, the system comprising:
a retail store offering furniture for sale;
furniture on display in said retail stored; and
an introduction mechanism in said retail store operable to initiate a dialogue in said retail store, said introduction mechanism including a surprise mechanism.

30. The system of claim 29, wherein a portion of said retail store is segregated and has an entryway through which customers enter and exit said portion of said retail store and said portion of said retail store showcasing furniture from a single entity, and further comprising:
a plurality of pieces of furniture that are produced by said single entity on display in said portion of said retail store;
a display in said portion of said retail store that indicates a delivery date for a piece of furniture in said portion of said retail store purchased that day; and
a cushion having a cover with a self-healing zipper located proximate to said entryway so that said cushion is readily available to demonstrate said self-healing zipper to a customer.

31. The system of claim 30, further comprising an upholstery display including samples of upholstery that can be selected for a multitude of said pieces of furniture on display in said portion of said retail store, each of said samples having a label, and wherein each of said pieces of furniture has a label that is keyed to said labels on said samples to identify which upholstery is available for each piece of furniture.

32. The system of claim 30, further comprising a supply of fiber filling that can be inserted into said pieces of furniture to demonstrate an ability of a customer to adjust a quantity of fiber filling in said furniture.

33. The system of claim 30, wherein at least one of said pieces of furniture has an upgraded seat deck having indicia indicating that said upgraded seat deck can be customized by a customer to have customer specified indicia.

34. The system of claim 30, wherein one of said pieces of furniture located proximate said entryway has at least one vent that allows air to move in and out of said piece of furniture to enhance performance of a cushion in said piece of furniture.

35. The system of claim 29, wherein said surprise mechanism is a tag to be worn by a customer in said retail store.

36. The system of claim 29, wherein said surprise mechanism is a ticket allowing entry to said retail store.
